(19) United States
(12) Patent Application Publication
(10) Pub. No.: US 2012/0043842 A1
(43) Pub. Date: Feb. 23, 2012

(54) Hydrodynamic bearing assembly and motor including the same

(75) Inventor: Tae Young Choi, Yongin (KR)

(73) Assignee: SAMSUNG ELECTRO-MECHANICS CO., LTD., Suwon (KR)

(21) Appl. No.: 13/067,467

(22) Filed: Jun. 2, 2011

(30) Foreign Application Priority Data
Aug. 17, 2010 (KR) 10-2010-0079475

(51) Int. Cl. H02K 7/08; F16C 32/06

(52) U.S. Cl. 310/90; 384/107

(57) ABSTRACT

Disclosed are a hydrodynamic bearing assembly and a motor including the same. The hydrodynamic bearing assembly may include a sleeve supporting a shaft to allow a top portion of the shaft to be protruded upwardly in an axial direction and including a coupling part of which a bottom end is protrusively formed, a base cover coupled with a bottom of the sleeve in the axial direction while maintaining a gap therebetween, and support part formed at an outer end portion of the base cover and formed to be protruded in the axial direction such that an outer peripheral surface thereof is in contact with and coupled to an inner peripheral surface of the coupling part of the sleeve.

### CROSS-REFERENCE TO RELATED APPLICATIONS

This application claims the priority of Korean Patent Application No. 10-2010-0079475 filed on Aug.17, 2010, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same, and more particularly, to a hydrodynamic bearing assembly allowing for increased stability by improving an unmating force and a motor including the same.

2. Description of the Related Art

An information storage device, a hard disk drive (HDD) uses a read/write head to write data to, or read data from a disk.

The hard disk drive requires a disk driving device capable of driving a disk, and, as the disk driving device, a small-sized spindle motor is used.

The small-sized spindle motor uses a hydrodynamic bearing assembly and a lubricating fluid is interposed between a shaft and a sleeve of the hydrodynamic bearing assembly to support the shaft by fluid pressure generated from the lubricating fluid.

Further, a bottom end of the sleeve is coupled with a base cover in such a manner as to have a gap therebetween, in order to receive the lubricating fluid. As a method of fixing the base cover to the sleeve, various methods such as welding, caulking, bonding, or the like, may be used, which may be optionally applied according to a structure and a process of a product.

However, a welding method is advantageous in shortening working time and improving sealability, but may change a dimension of the sleeve due to tension of the sleeve and the base cover after welding, in view of the process characteristics of the welding, thereby causing characteristic defects.

Further, a bonding method has an unmating force smaller than the welding method, such that a bond layer may be broken when a mechanical impact or thermal impact is applied, and, as a result, may cause a fatal flaw in performance.

In addition, a caulking method requires a separate structure for caulking, such that the process thereof is complicated.

Therefore, research into a hydrodynamic bearing assembly capable of withstanding external impacts by improving an unmating force while having a simplified process and a motor including the hydrodynamic bearing assembly is urgently needed.

### SUMMARY OF THE INVENTION

An object of the present invention provides a hydrodynamic bearing assembly allowing for an increased unmating force in a hydrodynamic bearing and sufficiently withstanding a high-speed rotation of a motor and external impacts by changing a structure of a base cover, and a motor including the same.

According to an exemplary embodiment of the present invention, there is provided a hydrodynamic bearing assembly including a sleeve supporting a shaft to allow a top portion of the shaft to be protruded upwardly in an axial direction and including a coupling part of which a bottom end is protrusively formed; a base cover coupled with a bottom of the sleeve in the axial direction while maintaining a gap therebetween; and a support part formed at an outer end portion of the base cover and formed to be protruded in the axial direction such that an outer peripheral surface thereof is in contact with and coupled to an inner peripheral surface of the coupling part of the sleeve.

The support part may be formed to be protruded upwardly or downwardly in the axial direction along the inner peripheral surface of the coupling part.

The support part may be protruded upwardly and downwardly in the axial direction along the inner peripheral surface of the coupling part.

The coupling part may be provided with an insertion groove concavely formed along the inner peripheral surface to allow the support part to be inserted thereinto.

The insertion groove of the coupling part may be concavely formed to have a shape corresponding to the support part.

According to another exemplary embodiment of the present invention, there is provided a motor including: a hydrodynamic bearing assembly including a sleeve supporting a shaft to allow a top portion of the shaft to be protruded upwardly in an axial direction and including a coupling part of which a bottom end is protrusively formed, a base cover coupled with a bottom of the sleeve in the axial direction while maintaining a gap therebetween, and a support part formed at an outer end portion of the base cover and formed to be protruded in the axial direction such that an outer peripheral surface thereof is in contact with and coupled to an inner peripheral surface of the coupling part of the sleeve; a stator including a core coupled with an outer peripheral surface of the sleeve and having a coil wound therearound for generating a rotational driving force; and a rotor having a magnet mounted on a surface thereof, the magnet facing the wound coil in order to be rotated with respect to the stator.

The support part maybe formed to be protruded upwardly and downwardly, or upwardly or downwardly in the axial direction along the inner peripheral surface of the coupling part.

The coupling part may be provided with an insertion groove that is concavely formed along the inner peripheral surface to allow the support part to be inserted thereinto.

The insertion groove of the coupling part may be concavely formed to have a shape corresponding to the support part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an exemplary embodiment of the present invention;

FIG. 2 is a schematic cross-sectional view of a motor according to another exemplary embodiment of the present invention;

FIG. 3 is a schematic cross-sectional view of a hydrodynamic bearing assembly provided in the motor according to the exemplary embodiment of the present invention;

FIGS. 4 through 7 are schematic cross-sectional views of other examples of section A shown in FIG. 3; and

FIG. 8 is a schematic cross-sectional view of a recording disk driving device having the motor mounted thereon according to the exemplary embodiment of the present invention.

### DETAILED DESCRIPTION OF THE PREFERRED EMBODIMENT

Exemplary embodiments of the present invention will now be described in detail with reference to the accompanying drawings. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

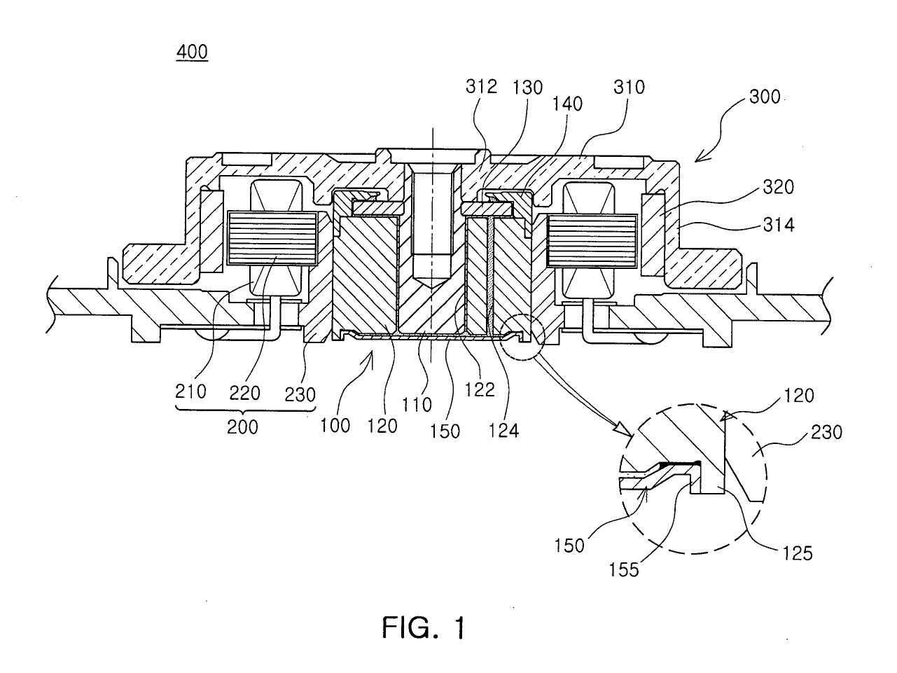

FIG. 1 is a schematic cross-sectional view of a motor according to an exemplary embodiment of the present invention.

Referring to FIG. 1, a motor 400 according to an exemplary embodiment of the present invention may include a hydrodynamic bearing assembly 100, a stator 200, and a rotor 300.

The hydrodynamic bearing assembly 100 may include a shaft 110, a sleeve 120, a thrust plate 130, a cap member 140, and a base cover 150.

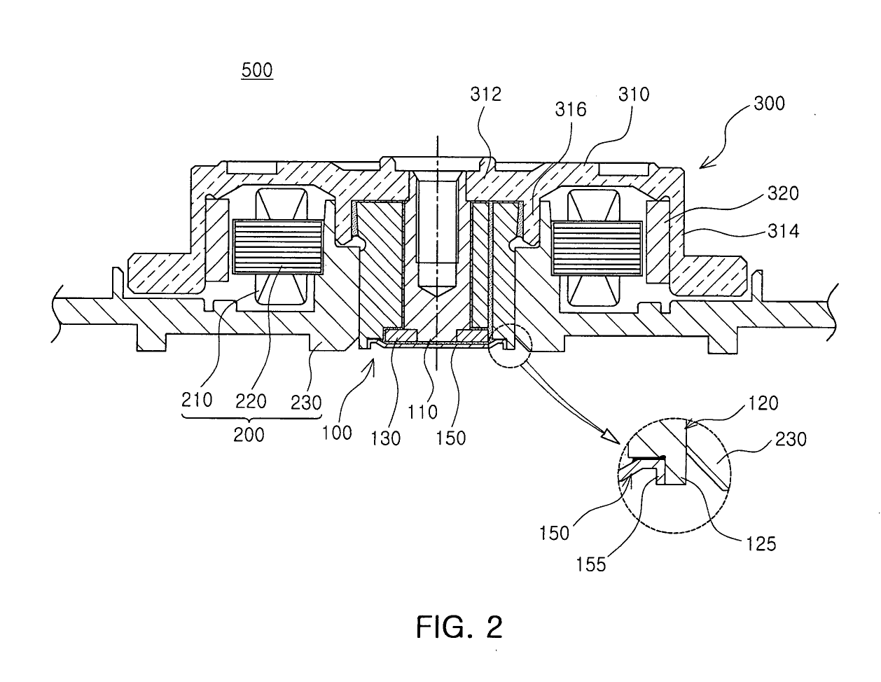

First, in defining terms regarding directions, when viewed in FIGS. 1 and 2, an axial direction refers to a vertical direction based on the shaft 110. An outer-diameter direction refers to an outer edge direction of the rotor 300 based on the shaft 110 and an inner diameter direction refers to a central direction of the shaft 110 based on an outer edge of the rotor 300.

The sleeve 120 may support the shaft 110 such that a top portion of the shaft 110 is protruded upwardly in an axial direction and may include a coupling part 125 of which a bottom end is protrusively formed.

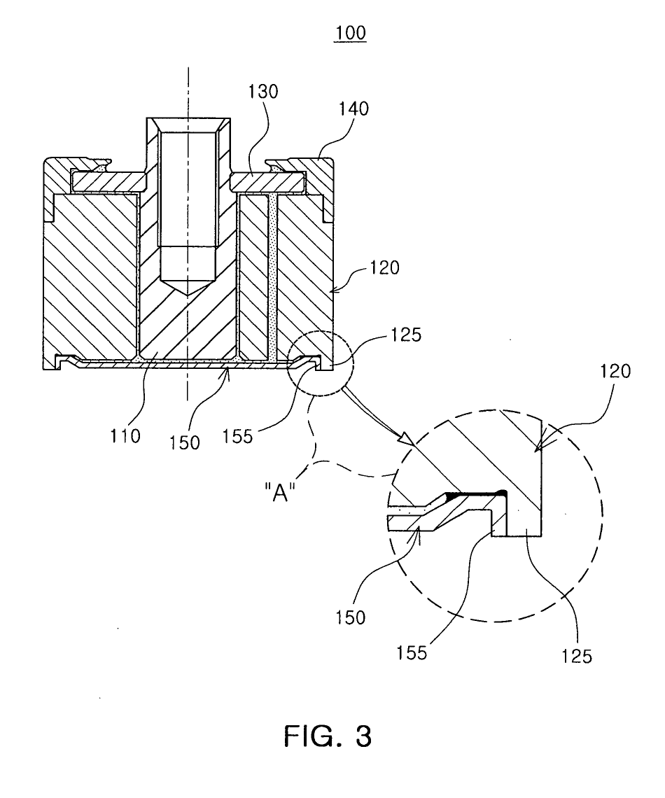

The coupling part 125 has a configuration in which it is coupled to and in contact with a support part 155 of the base cover 150 to be described below, which will be described in detail with reference to FIGS. 3 through 7.

The sleeve 120 may be formed by forging Cu or Al or sintering a Cu—Fe-based alloy powder or a SUS-based powder.

In this case, the shaft 110 is inserted into a shaft hole 122 of the sleeve 120 to have a micro gap therebetween, the micro gap being filled with a lubricating fluid, and the rotation of the rotor 300 may be more smoothly supported by a radial dynamic groove provided on at least one of an outer diameter of the shaft 110 and an inner diameter of the sleeve 120.

The radial dynamic groove is formed in an inner side the sleeve 120, that is, an inner portion of the shaft hole 122 of the sleeve 120 and forms a pressure deflected to one side at the time of the rotating of the shaft 110.

However, as described above, it is to be noted that the radial dynamic groove is not necessarily provided at the inner side of the sleeve 120 and may be provided in an outer-diameter portion of the shaft 110 and the number of radial dynamic grooves is not limited.

The sleeve 120 is provided with a bypass channel 124 formed to allow the top and the bottom of the sleeve 120 to be in communication with each other, thereby dispersing and balancing the pressure of the lubricating fluid in the hydrodynamic bearing assembly 100 and moving the lubricating fluid in order to discharge bubbles, or the like, present in the hydrodynamic bearing assembly 100 through circulation.

In this case, the bottom of the sleeve 120 in the axial direction may be provided with the base cover 150 that is coupled with the sleeve 120 while maintaining a gap therebetween, the gap receiving the lubricating fluid.

The base cover 150 may serve as a bearing supporting the bottom surface of the shaft 110, as the base cover 150 receives the lubricating fluid in the gap between the base cover 150 and the sleeve 120.

In addition, the base cover 150 may include the support part 155 that is formed at an outer end portion thereof, may be formed to be protruded in an axial direction, and may have an outer peripheral surface coupled with an inner peripheral surface of the coupling part 125 of the sleeve 120. The coupling structure of the support part 155 and the coupling part 125 will be described in detail with reference to FIGS. 3 through 7.

The thrust plate 130 includes a hole that is disposed upwardly of the sleeve 120 in an axial direction and corresponds to a cross section of the shaft 110 at the center thereof, such that the shaft 110 may be inserted into the hole.

In this case, the thrust plate 130 is separately manufactured and may be coupled with the shaft 110; it may be integrally formed with the shaft 110 at the time of the manufacturing thereof and is rotated along the shaft 110 at the time of the rotation movement of the shaft 110.

In addition, the top surface of the thrust plate 130 may be provided with a thrust dynamic groove that provides a thrust dynamic pressure to the shaft 110.

As described above, the thrust dynamic groove is not necessarily formed on the top surface of the thrust plate 130 and may also be formed on the inner peripheral surface of the cap member 140 corresponding to the top surface of the thrust plate 130, which will be described below, or the top surface of the sleeve 120 corresponding to the bottom surface of the thrust plate 130.

The cap member 140 is a member that is press-fitted in the top portion of the thrust plate 130 to seal the lubricating fluid between the cap member 140 and the thrust plate 130, and a circumferential groove is formed in an outer-diameter direction such that the cap member 140 is press-fitted in the thrust plate 130 and the sleeve 120.

The bottom surface of the cap member 140 may have a protrusion in order to seal the lubricating fluid. This is because that a capillary phenomenon and the surface tension of the lubricating fluid are used in order to prevent the lubricating fluid from being leaked to the outside at the time of the driving of the motor.

The stator 200 may include a coil 210, a core 220, and a base 230.

In other words, the stator 200 may be a fixing structure that includes the coil 210 generating an electromagnetic force having a predetermined size at the time of the applying of power and a plurality of cores 220 around which the coil 210 is wound.

The core 220 is fixedly disposed on the top of the base 230 on which a printed circuit substrate (not shown) printed with a circuit pattern is provided, and the top surface of the base 230 corresponding to the winding coil 210 may be provided with a plurality of coil holes having a predetermined size penetrating through the top surface thereof in order to expose the winding coil 210 downwardly and the winding coil 210 may be electrically connected with the printed circuit board (not shown) in order to supply external power.

The outer peripheral surface of the sleeve 120 may be press-fittedly inserted into the base 230 and fixed thereto, and the core 220 on which the coil 210 is wound may also be inserted into the base 230. The base 230 and the sleeve 120 may be assembled by applying an adhesive to the inner surface of the base 230 or the outer surface of the sleeve 120.

The rotor 300 is a rotating structure that is rotatably provided with respect to the stator 200 and may include a rotor case 310 having an annular ring magnet 320 corresponding to the core 220 while having a predetermined interval therefrom provided at an inner peripheral surface thereof.

The magnet 320 is a permanent magnet of which an N pole and an S pole are alternately magnetized in a circumferential direction to generate a magnetic force having a predetermined strength.

In this case, the rotor case 310 may be configured of a hub base 312 that is press-fitted and fixed to the top portion of the shaft 110 and a magnet support part 314 that extends in an outer-diameter direction from the hub base 312 and is bent downwardly in an axial direction to support the magnet 320 of the rotor 300.

FIG. 2 is a schematic cross-sectional view of a motor according to another exemplary embodiment of the present invention.

Referring to FIG. 2, a motor 500 according to another exemplary embodiment of the present invention has the same configuration and effect as that of the exemplary embodiment above described, other than the thrust plate 130 and a part 316 of the rotor case 310, and thus, the following description thereof will be omitted.

The thrust plate 130 is disposed at the bottom of the sleeve 120 in an axial direction and coupled with the shaft 110.

That is, the thrust plate 130 may be coupled with the shaft 110 by screwing, bonding, welding, or the like, and the thrust dynamic groove that provides the thrust dynamic pressure to the shaft 110 may be formed on at least one of the top surface and the bottom surface of the thrust plate 130.

In this case, as compared with the exemplary embodiment above described, the disposition position of the thrust plate 130 based on the shaft 110 is different, but the function and effect of the thrust plate 130 are the same.

Further, the rotor case 310 of the motor 500 according to another exemplary embodiment of the present invention may be configured of the hub base 312 that is press-fitted and fixed to the top portion of the shaft 110 and the magnet support part 314 that extends in an outer-diameter direction from the hub base 312 and is bent downwardly in an axial direction to support the magnet 320 of the rotor 300.

In addition, the rotor case 310 may provided with the wall part 316 formed to extend downwardly in an axial direction in order to seal the lubricating fluid between the wall part 316 and the sleeve 120.

The interval between the wall part 316 and the sleeve 120 maybe gradually widened downwardly in an axial direction in order to prevent the lubricating fluid from being leaked to the outside at the time of the driving of the motor. To this end, the outer peripheral surface of the sleeve 120 corresponding to the wall part 316 maybe formed to be tapered in an inner-diameter direction.

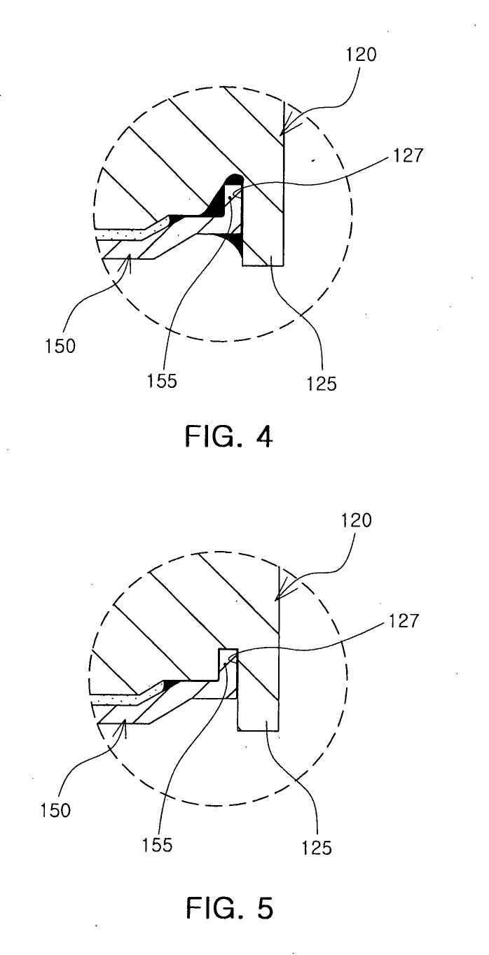

FIG. 3 is a schematic cross-sectional view of a hydrodynamic bearing assembly provided in the motor according to the exemplary embodiment of the present invention and FIGS. 4 through 7 are schematic cross-sectional views of other examples of section A shown in FIG. 3.

Referring to FIGS. 3 through 7, the hydrodynamic bearing assembly 100, provided in the motor 400 according to the exemplary embodiment of the present invention, may include a configuration of the coupling structure of the base cover 150 and the sleeve 120.

The base cover 150 may include the support part 155 at the outer end portion thereof such that the outer peripheral surface thereof is coupled to and in contact with the inner peripheral surface of the coupling part 125 of the sleeve 120.

As shown in FIG. 3, the support part 155 is formed at the outer end portion of the base cover 150 and is protrudedly formed downwardly in an axial direction to be coupled with the coupling part 125 of the sleeve 120.

That is, the support part 155 may mean that the outer end portion of the base cover 150 is formed to be bent downwardly in an axial direction, which may expand an area coupled with the sleeve 120.

As a result, the area to which the adhesive is applied is expanded, thereby increasing the unmating force allowing for sufficiently withstanding external impacts, or the like, in the axial direction.

Generally, the unmating force indicates a degree to which the coupling of the base cover 150 and the sleeve 120 is maintained by the impact upwardly or downwardly in an axial direction and may depend on the coupling area in the axial direction between the base cover 150 and the sleeve 120.

Therefore, the hydrodynamic bearing assembly 100 according to the exemplary embodiment of the present invention may increase the coupling area in which the base cover 150 is coupled with the coupling part 125 of the sleeve 120 through the support part 155 formed at the outer end portion of the base cover 150, thereby improving the unmating force.

In addition, as shown in FIGS. 4 and 5, the support part 155 of the base cover 150 may be formed to be protruded upwardly in the axial direction and the inner peripheral surface of the coupling part 125 of the sleeve 120 may be provided with an insertion groove 127 into which the support part 155 is inserted.

The insertion groove 127 may be concavely formed along the inner peripheral surface of the coupling part 125 and may be a groove having a shape corresponding to the shape of the support part 155.

When the insertion groove 127 is larger than the shape of the support part 155, an empty space within the insertion groove 127 may be filled with an adhesive and when the insertion groove 127 corresponds to the shape of the support part 155, the outer peripheral surface of the support part 155 may be in contact with and coupled to the inner surface of the insertion groove.

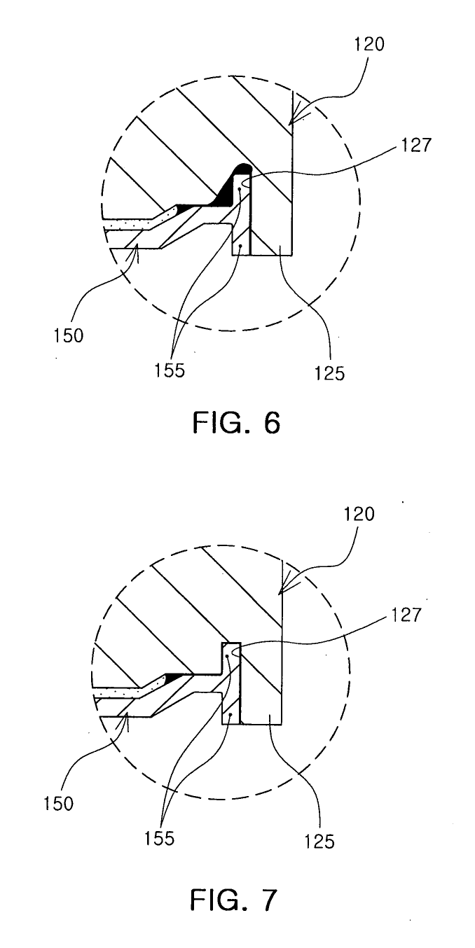

In addition, as shown in FIGS. 6 and 7, the support part 155 of the base cover 150 may be formed to be protruded upwardly and downwardly in an axial direction and the inner peripheral surface of the coupling part 125 of the sleeve 120 may be provided with the insertion groove 127 into which the portion of the support part 155, protruded upwardly is inserted.

In this case, the insertion groove 127 has the same configuration and effect as that shown in FIGS. 4 and 5 and has the same configuration and effect as in the above-mentioned exemplary embodiment, with the exception that the support part 155 is protruded in both directions, that is, upwardly and downwardly.

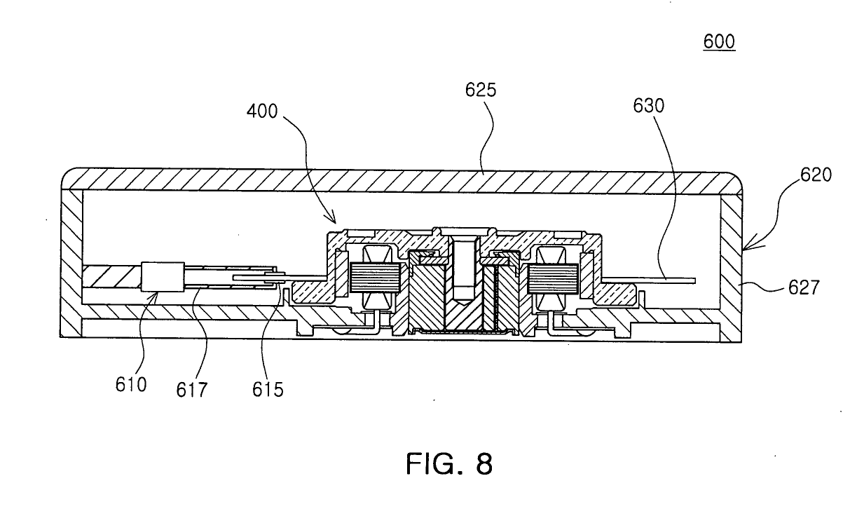

FIG. 8 is a schematic cross-sectional view of a recording disk driving device having the motor mounted thereon according to the exemplary embodiment of the present invention.

Referring to FIG. 8, a recording disk driving device 600 on which the motor 400 is mounted according to the exemplary embodiment of the present invention is a hard disk driving device and may include the motor 400, a head transfer part 610, and a housing 620.

The motor 400 has all of the characteristics of the motor according to the exemplary embodiment of the present invention described above and may have a recording disk 630 mounted thereon.

The head transfer part 610 may transfer a head 615 detecting information on the recording disk 630 mounted on the motor 400 to a surface of the recording disk to be detected.

In this case, the head 615 may be disposed on a support member 617 of the head transfer part 610.

The housing 620 may include a motor mounting plate 627 and a top cover 625 shielding the top of the motor mounting plate 627 in order to form an inner space accommodating the motor 400 and the head transfer part 610.

As set forth above, the hydrodynamic bearing assembly and the motor including the same according to the exemplary embodiments of the present invention may allow for the improvement of the unmating force so as to sufficiently withstand the external impact.

Further, the exemplary embodiments of the present invention may improve the unmating force to thereby improve the performance and the operation stability of the hydrodynamic bearing assembly.

As set forth above, the hydrodynamic bearing assembly 100 and the motors 400 and 500 including the same according to the exemplary embodiments of the present invention may expand the coupling area in which the support part 155 of the base cover 150 and the coupling part 125 of the sleeve 120 are coupled in the axial direction, thereby improving the unmating force.

Therefore, the unmating force is improved to increase the resistance force withstanding the external impact, thereby improving the stability of the motors 400 and 500.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly, comprising:
a sleeve supporting a shaft to allow a top portion of the shaft to be protruded upwardly in an axial direction and including a coupling part of which a bottom end is protrusively formed;
a base cover coupled with a bottom of the sleeve in the axial direction while maintaining a gap therebetween; and
a support part formed at an outer end portion of the base cover and formed to be protruded in the axial direction such that an outer peripheral surface thereof is in contact with and coupled to an inner peripheral surface of the coupling part of the sleeve.

2. The hydrodynamic bearing assembly of claim 1, wherein the support part is formed to be protruded upwardly or downwardly in the axial direction along the inner peripheral surface of the coupling part.

3. The hydrodynamic bearing assembly of claim 1, wherein the support part is protruded upwardly and downwardly in the axial direction along the inner peripheral surface of the coupling part.

4. The hydrodynamic bearing assembly of claim 1, wherein the coupling part is provided with an insertion groove concavely formed along the inner peripheral surface to allow the support part to be inserted thereinto.

5. The hydrodynamic bearing assembly of claim 4, wherein the insertion groove is concavely formed to have a shape corresponding to the support part.

6. A motor, comprising:
a hydrodynamic bearing assembly including a sleeve supporting a shaft to allow a top portion of the shaft to be protruded upwardly in an axial direction and including a coupling part of which a bottom end is protrusively formed, a base cover coupled with a bottom of the sleeve in the axial direction while maintaining a gap therebetween, and a support part formed at an outer end portion of the base cover and formed to be protruded in the axial direction such that an outer peripheral surface thereof is in contact with and coupled to an inner peripheral surface of the coupling part of the sleeve;
a stator including a core coupled with an outer peripheral surface of the sleeve and having a coil wound therearound for generating a rotational driving force; and
a rotor having a magnet mounted on a surface thereof, the magnet facing the wound coil in order to be rotated with respect to the stator.

7. The motor of claim 6, wherein the support part is formed to be protruded upwardly and downwardly, or upwardly or downwardly in the axial direction along the inner peripheral surface of the coupling part.

8. The motor of claim 6, wherein the coupling part is provided with an insertion groove that is concavely formed along the inner peripheral surface to allow the support part to be inserted thereinto.

9. The motor of claim 8, wherein the insertion groove is concavely formed to have a shape corresponding to the support part.
